(19) United States
(12) Patent Application Publication
(10) Pub. No.: US 2013/0013137 A1
(43) Pub. Date: Jan. 10, 2013

(54) Method for controlling an hybrid vehicle motorization device, and associated device

(75) Inventor: Stéphane Saint-Macary, Toulouse (FR)

(73) Assignee: CONTINENTAL AUTOMOTIVE FRANCE, TOULOUSE (FR)

(21) Appl. No.: 13/515,065

(22) PCT Filed: Oct. 18, 2010
(86) PCT No.: PCT/EP10/06341

§ 371 Date: Oct. 2, 2012

(30) Foreign Application Priority Data
Dec. 15, 2009 (FR) 0906045

(51) Int. Cl. B60W 20/00; B60K 6/442; B60W 10/08; B60W 10/02; B60W 10/06

(52) U.S. Cl. 701/22; 180/65.23; 903/903; 180/65.265

(57) ABSTRACT

A method for controlling a motorization device for an hybrid vehicle includes using alternatively two modes for connecting the wheels to the electric motor and to the internal combustion engine; a parallel mode in which the internal combustion engine drives the wheels directly, without electrical assistance; a series mode in which the electrical motor drives the wheels, with an intermittent use of the internal combustion engine only at its optimal operating point, for the purpose of recharging the battery regularly, the switch from one mode to the other being determined by a step for comparing between the consumption of the internal combustion engine in parallel mode, and the optimal consumption of the internal combustion engine to which are added the losses due to the activation of the electrical chain of the series mode.

The invention relates to the field of vehicles motorization. It relates more particularly to the motorizations called hybrid, comprising an electromechanical chain and an internal combustion engine. Yet more specifically, it relates to a method for managing a hybrid vehicle and the associated device.

With the progressive reduction in hydrocarbon reserves, new solutions for land vehicles motorization have been studied for several years. Amongst the latter, the hybrid motorization is a promising solution.

Note that a motorization system is called hybrid in that it consists of two different energy sources. These energy sources may be, for example and in the most usual case, a unit of the internal combustion engine (ICE) type and an electrical propulsion unit, which then usually comprises a system for storing electrical energy (SSEE) such as batteries or supercapacitors. As a simplification, the term “ICE engine” will be used to designate the internal combustion engine and the term “SSEE” to designate the system for storing electrical energy in the rest of the description.

These combinations, when well chosen, can make hybrid vehicles up to twice as efficient as conventional vehicles in terms of consumption, while providing similar performance and comfort. The hybrid systems have a range comparable to vehicles furnished with a conventional motorization of the internal combustion engine type, but reduce the polluting emissions and consumptions. In the rest of the description, consideration is given in particular to the hybrid combination of a vehicle, by a mechanical chain (ICE engine+transmission) and an integrated electromechanical chain.

The components of this electromechanical chain essentially consist of electrical machines controlled as a motor or a generator connected by an SSEE through electrical converters allowing these electrical machines to be controlled. These electrical converters may or may not be integrated into the electrical machines. For the purpose of simplification, the electrical converter driving the electrical machine in motor mode or generator mode will be considered to be a single entity that will be called simply the electrical machine.

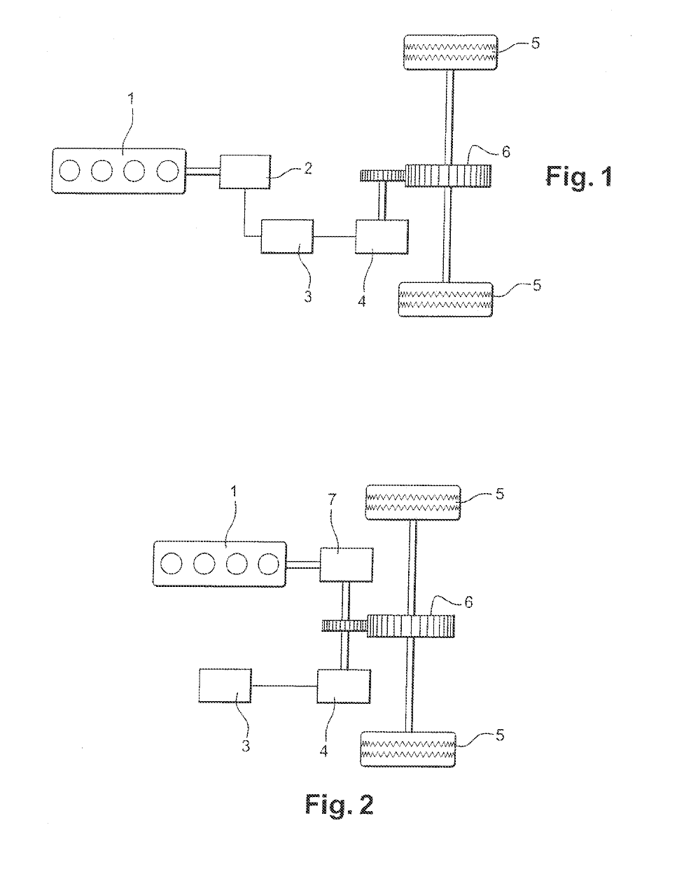

In the prior art, three large families of architecture are identified for the current hybrid vehicles, illustrated here by FIGS. 1 to 3. In these figures, the double lines represent the mechanical power transmission lines and the single lines the electrically-powered transmission lines.

In a first architecture, called “series” (see FIG. 1), an internal combustion engine (ICE) 1 is connected to a generator 2 which produces electricity. This electrical energy is stored in an SSEE 3 and then used to drive one or more electrical machines 4, which supply the power necessary for driving the wheels 5, via a differential 6, in order to propel the vehicle.

In this series architecture, the many steps for converting mechanical power into electrical power generate cumulative efficiency losses. However, they allow worthwhile control strategies and an optimization of the operation of the internal combustion engine (ICE). The overall efficiency of the system is thereby usually improved in journeys of the “urban cycle” type. In order to cover various types of journey, the range of the SSEE 3 should be increased. Naturally, the greater the storage capacity of the latter, the heavier and more costly it becomes. Purely for information, a range of 50 km in purely electrical mode assumes the carrying of batteries 3 weighing approximately 70 kg.

In a second architecture, called “parallel” (see FIG. 2), an ICE engine 1 associated with a transmission 7, on the one hand, and an electrical machine 4, on the other hand, are mechanically connected to the wheels 5 of the vehicle through a differential 6. The electromechanical chain then participates in the accelerations, in the retrieval of energy and optionally on hills and on start-up. Such a parallel hybrid system often provides good efficiency, when the additional torque provided by the electrical machine 4 in motor mode corresponds to the optimized zone (engine speed, torque) of the ICE engine 1. When outside this zone of optimized engine speed, the energy efficiency of the parallel hybrid system is no longer optimized. Specifically, the wheels 5 of the vehicle are connected to the ICE engine 1 through various mechanical gear-reduction stages and the optimized adjustment of the engine speed, amongst the speed stages proposed by the transmission, is not possible.

Nevertheless the advantage of this parallel architecture, relative to the series architecture, is that it is possible to disconnect the electrical mode when the latter provides no gain in terms of energy efficiency, which is usually the case at the high speeds of the vehicle.

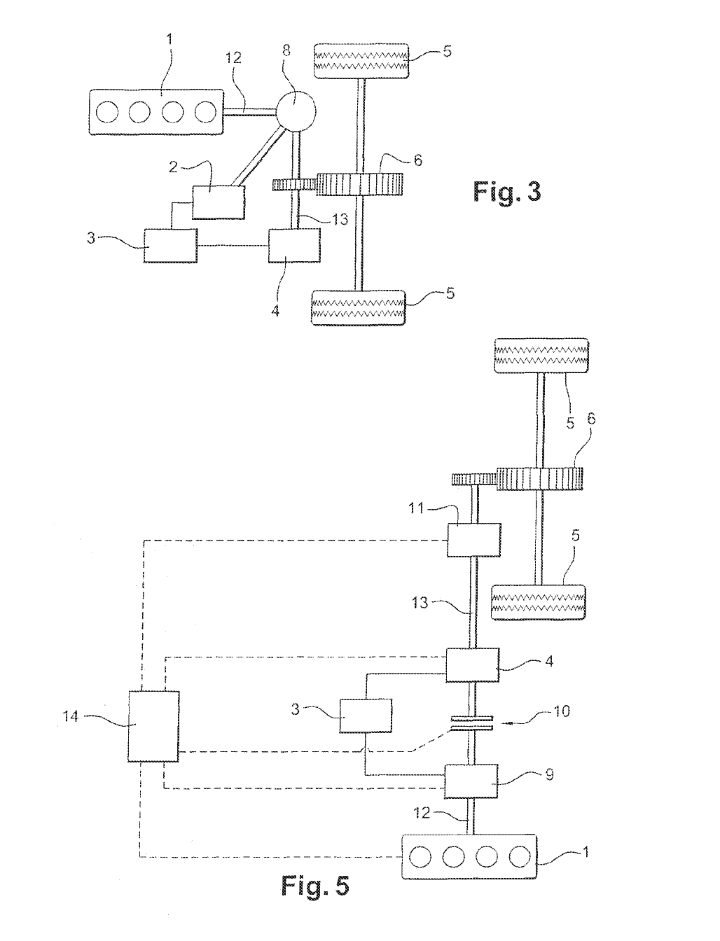

A third architecture called “series/parallel” (see FIG. 3) is a particular construction of the hybrid systems which makes it possible to switch from one mode (parallel or series) to another, progressively or not. In this series/parallel architecture, an ICE engine 1 is capable of driving the wheels 5 through a mechanical energy distributor 8 and a differential 6. The mechanical energy distributor 8 is in its turn connected to a generator 2, which converts a portion of the mechanical energy of the ICE engine 1 into electrical energy, which is stored in an SSEE 3. One or more electric motors 4 also drive the wheels 5 through the differential 6.

The mechanical energy distributor 8 distributes the mechanical power at will into two flows, by virtue of an epicyclic gear. A first portion of this mechanical power is used to drive the wheels 5 directly, and the other portion of this mechanical power is converted into electricity via the generator 2 in order to supply the electric motor 4 or to charge the SSEE 3. This architecture, having an epicyclic gear, benefits from the option of controlling the torque and the engine speed by cleverly distributing the power flows but without the benefit of the total independence of these two variables. A torque-speed dependence relation of the three shafts of the planetary gear does not make it possible to choose a torque and an engine speed that would correspond to a fully optimized operating point of the ICE.

In other words, the system controls the two drive sources 1, 4 in order to obtain a good efficiency of the ICE engine 1 as a function of the driving conditions.

In this way, at low speed, the performance of the series/parallel architecture is comparable to the series hybrids.

At high speed, it is comparable to the parallel hybrids.

This power-distribution structure is found in particular on the hybrid vehicles that are most widely marketed currently.

One of the drawbacks of such a system, in addition to its complexity of implementation and of control, is the virtually constant stressing of the electromechanical chain when the ICE engine 1 is active. The result of this is a reduction in efficiency of the system (ICE 1+generator 2+SSEE 3+motor 4+epicyclic gear 8) which can be of the order of 20%.

Specifically, the epicyclic gear of the energy distributor 8, because of its continuous transmission function,requires a fairly considerable portion of the power flows passing through the electromechanical conversion chain, thus adversely affecting the efficiency of the assembly.

It is clear that such an efficiency loss is harmful to the performance of the vehicle in terms of fuel consumption, which these days is becoming a fundamental criterion in the choice of vehicles by the users.

The object of the present invention is therefore to propose a device that addresses the problem explained above, namely the reduction of fuel consumption. A second object of the invention is to be simple and cheap to implement.

Accordingly, the subject of the invention is an hybrid land vehicle motorization, said device comprising a first mechanical power transmission line comprising an internal combustion engine connected to a first electrical machine, a second mechanical power transmission line comprising a second electrical machine capable of rotating wheels of the vehicle, the two electrical machines being able to be controlled as a motor or a generator, being connected to a system for storing electrical energy,

the device also comprising:
an “on-off” coupling-decoupling system for coupling-decoupling the two mechanical power transmission lines,
means for controlling these various elements, connected to a computer,
means for comparison between:

on the one hand, the consumption of the internal combustion engine in parallel mode, defined as a mode in which the shaft of the internal combustion engine drives the wheels via various members of mechanical gears, the two mechanical transmission lines being connected through the coupling device, that is to say the consumption of said internal combustion engine at a given moment without electrical assistance and,

on the other hand, an equivalent consumption computed on the basis of the optimal consumption of the internal combustion engine to which are added the losses due to the activation of the electrical chain of the series mode, defined as being a mode in which the traction of the vehicle is provided only by the second electrical machine, the two mechanical transmission lines being separated by the coupling device, an intermittent use of the internal combustion engine making it possible to recharge the system for storing electrical energy regularly in order to satisfy a continuous demand for power at the wheels.

It can be understood that the on-off coupling/decoupling system is a device of the clutch type making it possible to completely separate, from a mechanical point of view, the two mechanical power transmission lines. This coupling-decoupling system can also be replaced if required by the conventional clutch associated with the gearbox.

Preferably, the device also comprises a gearbox placed on one of the mechanical power transmission lines. This gearbox may be associated with its own conventional clutch system or else use the coupling-decoupling system used in this case as a gearbox clutch.

This arrangement makes it possible conventionally to use the internal combustion engine at its optimal operating point at several speeds of the vehicle.

Advantageously, the two electrical machines are sized at a nominal power of the order of 10 to 30 kW.

This power is generally half of the power of the electrical machines used in the prior art for comparable reductions in fuel consumption.

According to a preferred embodiment, the system for storing electrical energy is of the rapid charge and discharge type.

A second aspect of the invention is a method for controlling a device for driving a hybrid vehicle as explained, the method consisting in using at least two distinct architecture modes:
a parallel mode in which the shaft of the internal combustion engine drives the wheels via various members of mechanical gears, the two mechanical transmission lines being connected through the coupling device,
a series mode in which the traction of the vehicle is provided only by the second electrical machine, the two mechanical transmission lines being separated by the coupling device, an intermittent use of the internal combustion engine (start, stop) making it possible to recharge the system for storing electrical energy regularly in order to satisfy a continuous demand for power at the wheels.

The intermittent recharging of the SSEE by the ICE engine takes place through the first electrical machine.

In this case, according to a preferred embodiment, the switch from one mode to the other is determined by a step for comparing between the consumption of the internal combustion engine in parallel mode (that is to say the consumption of said internal combustion engine at a given moment without electrical assistance), and the equivalent consumption computed on the basis of the optimal consumption of the internal combustion engine to which are added the losses due to the activation of the electrical chain of the series mode.

According to various embodiments of the method:
In a configuration of the vehicle in low-power traction, the computer uses the series mode with intermittent use of the internal combustion engine. In this case, the computer controls the various members of the electromechanical chain allowing the intermittent use of the internal combustion engine.
In a configuration of traction of the vehicle at normal power, the computer uses the parallel mode, and the internal combustion engine is used only for driving the wheels.
In a configuration of traction of the vehicle at high power, for example in the event of considerable acceleration, the computer uses the parallel mode, and one or the two electrical machines are used in drive mode in order to provide an additional torque to the transmission shaft in order to drive the wheels in conjunction with the internal combustion engine.

It is understood that the invention proposes to optimize the method for managing a series/parallel system known hitherto while allowing a connection:
that is either direct between the ICE engine and the wheels, most frequently without stressing the electrical chain, which corresponds to a parallel mode. This configuration is activated in the operating conditions in which the ICE engine alone is more favorable (in terms of consumption) than the operation of the ICE engine driving the electrical chain (series mode), which therefore prevents reducing the overall efficiency of the system.
or is indirect between the ICE engine and the wheels by stressing the electrical chain, which corresponds to a series mode. This configuration is activated in the operating conditions in which the ICE engine would not be optimized if the connection had been direct.

In this second configuration, the ICE engine charges the SSEE through the first electrical machine (used in generator mode), at its optimal operating point, that is to say at its operating point (engine speed, torque) corresponding to the best (that is to say the lowest) fuel consumption while the second electrical machine (used in motor mode) delivers to the wheels the power requested by the driver. This operating mode necessarily induces rapid phases of operating alternation of the ICE engine (charging the SSEE at the optimal operating point of the ICE) with phases of stopping of the ICE engine (discharging the SSEE). Naturally, for any ICE engine there is not only one optimal operating point, but a set of operating points (torque, engine speed) which define an optimal operating zone corresponding to the zone of least fuel consumption.

The idea is therefore to use the ICE engine intermittently (according to a “on-off” operating mode) in its optimal operating zone, that is to say in the operating zone corresponding to the lowest fuel consumption.

This can be achieved using an electrical machine and an SSEE that are of reduced size, relative to the prior art of series/parallel hybrid architectures. Specifically, since the ICE engine is used only close to its optimized operating point, and the frequency of the starting and stopping phases of the ICE adversely affects the average consumption of the ICE slightly or not at all, the ICE can thus provide the power in “on-off” slots markedly more frequently without adversely affecting its efficiency, so it becomes unnecessary to recharge a large SSEE. This new architecture is therefore very economical and additionally much lighter than the existing solutions.

It can be understood that in general, the electrical assistance (in terms of reduction in fuel consumption) is of value only when it allows the ICE engine to operate generally at higher efficiency levels while taking account of the losses caused by the use of the electrical chain. Questions should constantly be asked concerning the value of stressing or not stressing the electrical chain. The management of the driving of the wheels according to this comparison forms the object of the present invention.

The objects and advantages of the invention will be better understood on reading the description and the drawings of a particular embodiment that are given as nonlimiting examples, and for which the drawings represent:

FIG. 1 (already cited): Diagram of the energy circuit for a series hybrid system;

FIG. 2 (already cited): Diagram of the energy circuit for a parallel hybrid system;

FIG. 3 (already cited): Diagram of the energy circuit for a series/parallel hybrid system;

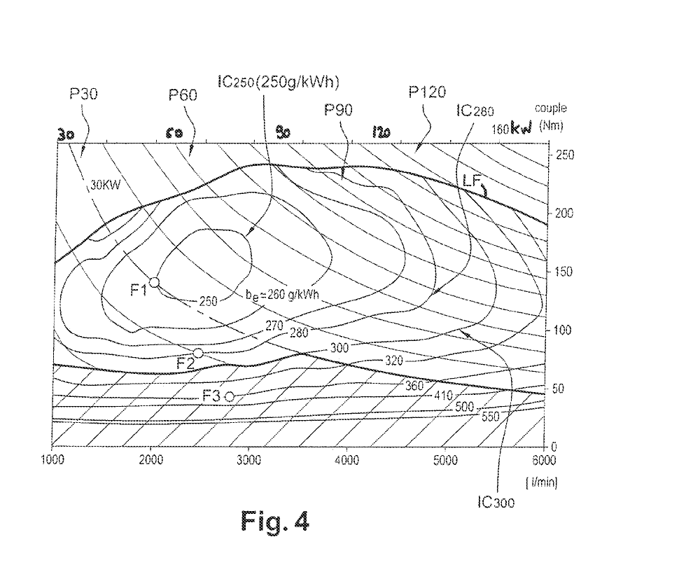

FIG. 4: Map of consumption of an internal combustion engine (ICE) of the gasoline type;

FIG. 5: A schematic view of a series/parallel hybridation device according to the invention.

FIG. 5 illustrates in a simplified manner the elements of a driving device according to the invention. This finds its place in a land vehicle such as a motor vehicle with hybrid motorization.

Initially, the device comprises an internal combustion engine 1, of the gasoline type in the present nonlimiting example. Such an ICE engine 1 is known per se and is therefore not explained in greater detail here.

It then comprises a first electrical machine 9, placed on a first mechanical power transmission line 12, connected to the ICE engine 1.

The functions of this first electrical machine 9 are:

When it is used in motor mode:
to operate the ICE engine 1 for the purpose of starting it,
to assist the ICE engine 1 during the phases of considerable accelerations of the vehicle.

And, when it is used in generator mode:
to transmit slots of energy from the ICE engine 1 to a system for storing electrical energy (marked SSEE for simplification in the rest of the description) 3,
to rapidly slow down the ICE engine 1 for the purpose of stopping it,
to recover a portion of the recoverable kinetic energy of the vehicle during the deceleration phases.

The device also comprises a second electrical machine 4, which is also connected to the SSEE 3.

The functions of this second electrical machine 4 are:

When it is used in motor mode:
to transmit all of the requested power to the wheels 5, in series mode,
to transmit a portion of the requested power during the phases of considerable acceleration of the vehicle in parallel mode.

And, when it is used in generator mode:
to recover all or some of the recoverable kinetic energy of the vehicle during the deceleration phases, irrespective of the mode used.

Since the object of the invention is not a distribution of the power between the ICE engine 1 and the electrical generator motors 4, 9, but an optimized use of the ICE engine 1 with optional spot electrical assistance by these motors if necessary, the two generator motors 4, 9 can be sized at a relatively low power, for example 10 to 30 kW. This distinguishes it from the prior art in which typically an electric motor of 50 kW and a generator of 30 kW are used.

The second electrical machine 4 is connected to the wheels 5 of the vehicle by means of a second mechanical transmission line 13 which comprises a transmission member 11, consisting of a gearbox and optionally a gearbox clutch device, and a differential 6.

The function of the gearbox is to allow both the ICE engine 1 and the second electrical machine 4 to operate at satisfactory torques and engine speeds, corresponding to their optimized operating range or zone. The gearbox is of a type known to those skilled in the art.

The device also comprises, on the mechanical power transmission line of the ICE engine 1, downstream of the first electrical machine 9, and upstream of the second electrical machine 4, a device of the clutch type 10 making it possible to achieve a coupling-decoupling of the two portions 12, 13 of said mechanical power transmission line. This clutch 10 is the element that allows the switch from series mode to parallel mode. This clutch is of the type known to those skilled in the art.

As has been seen, the SSEE 3 is connected to the two electrical machines 4, 9. In series mode, the SSEE 3 serves as a buffer stage, on the one hand by rapidly storing the energy supplied by the ICE engine 1 when it operates at its optimal point, during its active phase, and on the other hand by delivering the continuous power requested to the wheels 5.

In series or parallel mode, the SSEE 3 makes it possible to recover a portion of the kinetic energy of the vehicle during the deceleration phases.

Finally, in parallel mode, the SSEE can supply additional energy during the acceleration phases.

It is important for the SSEE 3 to be able to be charged and discharged very rapidly, so that the ICE engine 1 does not have the time to cool down between two operations. The SSEE 3 must therefore be of small capacity (a few tens of Wh), relative to the prior art, which is very advantageous in terms of cost and onboard weight.

The device also comprises a computer 14 connected to the main elements of the motorization described, notably the two electrical machines 4, 9, the SSEE 3, the ICE engine 1, the coupling-decoupling system 10 and the transmission member 11.

It has been found that the device, as seen in FIG. 5, has several differences relative to the prior art of hybrid architectures, and notably:
a) a clutch 10 allowing the coupling-decoupling of the two portions 12, 13 of the mechanical connection,
b) two low-power electrical machines 4, 9,
c) a low-capacity SSEE 3,
d) a transmission member 11 comprising a gearbox and optionally a gearbox clutch device.

Relative to the “series/parallel” hybrid configuration described above and illustrated by FIG. 3, the clutch 10+electrical machine 9 unit of the device according to the invention seems, on first analysis, to be similar to the energy distributor 8+electric generator 2 unit of the hybrid prior art. In fact, this is not the case.

In the first place, the nominal powers of the two generator motors of the prior art are provided to supply additional powers to the ICE engine that are of sufficient consequence (between 30 to 50% of the total available power) to allow the ICE 1 to be reduced accordingly.

This leads to entirely modifying the architecture of the conventional vehicle in order to hybridize it.

Secondly, in the prior art, the epicyclic gear of the energy distributor 8 never makes it possible to completely dispense with the transfer of a portion of the mechanical energy to the electrical generation chain, and permanently generates a loss of efficiency that may be up to 20%.

The choice, for the device according to the invention, of a clutch 10 and of a group of two electrical machines 4, 9 of low power is therefore motivated, on the one hand, by a great simplicity of control which is demonstrated by the control method described, and on the other hand, by the relatively minor modifications made to incorporate the electromechanical chain leading to the hybridization of the vehicle.

Since the ICE engine for its part sustains little or no power reduction, it can remain identical to that of a comparable conventional vehicle.

Moreover, the dimensions of the heat dissipating elements necessary for the correct operation of the members of the electromechanical chain (electrical machines, SSEE, converters etc.) are proportional to the nominal power that they must transfer and will therefore be substantially reduced in consequence.

The fuel economies are considerable even with low powers of onboard electrical machines.

A notable objective of the invention is to use the electrical assistance supplied by the electrical machines 4, 9 judiciously. In summary, the method for controlling a hybrid architecture according to the invention therefore consists in using two modes: a first mode called “parallel”, and a second mode called “intermittent series”.

The parallel mode is obtained when the clutch 10 is in the engaged position. The mechanical connection is connected between the ICE engine 1 and the wheels 5 via the various gear-reduction members of the transmission devices. In this first mode, the ICE engine 1 drives the wheels 5, with or without electrical assistance (assistance only in the phase of considerable acceleration) of the electrical machines 4 and/or 9. It is important to note that, in this case, the ICE engine is then not used to charge the SSEE 3. The two electrical machines 4 and/or 9 can recover the recoverable kinetic energy of the vehicle during the deceleration phases (generator mode).

In the intermittent series mode, the clutch 10 is in the disengaged position. The mechanical connection is therefore disconnected between the ICE engine 1 and the wheels 5.

In this second mode, the wheels are driven by the second electrical machine 4. The ICE engine 1 is used intermittently.

In this intermittent series mode, the computer 14 manages the stopping and starting phases of the injection system of the ICE engine in synchronous manner relative to the controlling of the two electrical machines. The two electrical machines have different functions. First of all, in the active phase of the ICE engine, the first electrical machine 9 drives the ICE engine in order to start it (motor mode). Then, when the ICE engine is started, the computer 14 authorizes the system of injecting fuel in the ICE so that the latter is in the optimal operating zone (engine speed, torque) and controls the electrical machine 9 to generator mode in order to transmit the energy from the ICE engine 1 to the SSEE which is charged up. Finally, when the SSEE is sufficiently charged, the computer 14 controls the stopping of the fuel injection system of the ICE engine and the electrical machine 9, still in generator mode, contributes to the deceleration of the ICE engine by retrieving a portion of the kinetic energy from the moving parts of the ICE engine. In the inactive phase of the ICE engine (total stoppage of the ICE engine), the electrical machine 9 is also stopped. On the other hand, at the same time, the request for power at the wheels is fully supplied by the SSEE which is discharged through the second electrical machine 4. The latter operates in this case either in motor mode (traction of the vehicle) or in generator mode (deceleration of the vehicle).

By making it possible to work on the two modes, parallel and intermittent series, the control method according to the invention also allows standard hybrid functions, of the type of assistance of the two electrical motor-generators 4, 9 to the wheels 5 during considerable accelerations (a function known as “boost”), energy recovery on braking by the two electrical motor-generators 4, 9 and automatic stopping of the ICE engine 1 at the time of each stop of the vehicle (a function known as “stop & start” or “stop & go”).

In order to switch from one mode to the other, the method according to the invention comprises a step of comparing between the consumption of the ICE engine 1 in parallel mode (that is to say the consumption of the ICE engine 1 at a given moment without electrical assistance), and the optimal consumption of the ICE engine 1 to which are added the losses due to the activation of the electrical chain of series mode.

When the consumption of the ICE engine 1 in parallel mode is less than the equivalent consumption of the “ICE (optimal)+losses of the electrical chain in series mode” assembly, then the parallel mode is activated and the ICE engine 1 operates on its own.

On the contrary, when the consumption of the ICE engine in parallel mode is greater than the equivalent consumption of the “ICE (optimal)+losses of the electrical chain in series mode” assembly, then the ICE engine 1 operates in series mode intermittently. That is to say, either it operates at its optimal operating point in order to charge the SSEE 3, or it is stopped. In these two cases corresponding to the intermittent series mode, the second electrical machine 5 alone transmits the power to the wheels.

It is known, in the case of a vehicle with conventional propulsion (not hybrid, with an ICE engine only) to associate a fuel consumption (or an energy efficiency) with each given operating point of the vehicle, that is to say with a rotation speed of the engine shaft (in rpm) and a torque on the shaft (in Nm).

The graphic representation of this function is illustrated in FIG. 4, in which the axes represent on the x coordinate the engine speed in revolutions/minute, and on the y coordinate the engine torque (in Nm). The closed curves IC then represent lines of isoconsumption of the engine, included in the present nonlimiting example, between 250 g/kWh and 550 g/kWh. In other words, all the points corresponding to the same consumption are linked together to form “isoconsumptions” in the plane (engine speed torque) of the ICE engine. The optimal operating zone of the ICE engine is then, as can be understood, the zone lying in the closed curve IC₂₅₀ and contains the operating points of the ICE engine at which the consumption is equal to 250 g/kWh. The graphic also illustrates, via the high curve LF, the limit of the operating range of the internal combustion engine.

The second family of curves P, substantially parallel with one another, corresponds to the power delivered by the engine in kW, for each torque and number of revolutions per minute. The curves P range in the present example from 10 to 160 kW. The curve P₃₀ corresponding to the value 30 kW is in this instance indicated in dashed lines.

In order to understand the value from switching from one mode to the other, the choice is taken to study various operating points of the ICE engine by using either the parallel mode or the series mode.

Take for example a load at the wheels corresponding to an operating point of consumption equal to 250 g/kWh (the point F1 in FIG. 4), that is to say equal to the best consumption of the ICE engine in question and corresponding to the nominal power of the first electrical machine 4.

In parallel mode, this consumption point remains on average equal to 250 g/kWh because the electromechanical chain is not activated and no electrical loss adversely affects the efficiency.

For this same load at the wheels, by using the series mode, the operating point of the ICE engine must take account of the losses generated by the use of the electromechanical chain, namely close to 20%. The power of the ICE engine in order to compensate for the losses must be increased by as much, which leads to an equivalent consumption of the ICE engine 1 of around 300 g/kWh.

There is therefore no value in stressing the electromechanical chain for this point F1 of operation of the ICE engine 1. It is therefore preferable to have a direct link between the ICE engine 1 and the wheels 5 of the vehicle and to operate the ICE engine 1 at the point F1 of least consumption.

The same applies if the ICE engine 1 rotates close to the ideal consumption point, for example at 280 g/kWh (point F2). Specifically, there is no point in forcing the engine to rotate at 250 g/kWh (point F1) and to stress the electromechanical chain, since that is the equivalent of an equivalent average consumption of 300 g/kWh, higher than that of the starting point (280 g/kWh). It is therefore preferable for this point to remain in parallel mode, that is to say to drive the wheels 5 directly with the ICE engine 1.

On the other hand, if the operating point of the ICE engine 1 is equivalent to a consumption of 360 g/kWh (point F3 in FIG. 4), that is to say far from the optimal consumption of 250 g/kWh (point F1), it becomes worthwhile to switch to intermittent series mode. The equivalent average consumption of the ICE engine then becomes that of the optimum point plus the losses of the series link, namely 300 g/kWh, (point F1) and it however remains below the starting consumption (360 g/kWh).

It is understood that there is a limit of consumption for the ICE engine 1 beyond which it becomes worthwhile to switch to intermittent series mode; this limit point in our example is situated around 300 g/kWh.

For this point F3, it is therefore worthwhile to switch to intermittent series mode.

In this series mode, the wheels 5 are then driven by the second electrical machine 4. The stoppages of the ICE engine 1 are necessary so as to not to overcharge the SSEE 3 which is of small capacity, but they must be of short duration so as not to allow the ICE engine 1 to cool down too much, which could harm the quality of combustion of the ICE engine and thus contribute to increasing the pollutant emissions rates.

Naturally, in this series mode, the power necessary for the traction of the wheels must be compatible with the available power of the SSEE 3 and of the second electrical machine 4. Moreover, in order to allow the alternation of charging and discharging phase of the SSEE by the ICE engine, the average power demanded at the wheels must be less than the peak power delivered by the ICE engine during the charging phases of the SSEE, namely 30 kW in our example.

In other words, and with reference to FIG. 4, the intermittent series mode (clutch disengaged) makes it possible to improve the overall consumption of the vehicle for the efficiency points of the ICE engine 1 greater than 300 g/kWh, and for a traction power of less than 30 kW in this example.

It is understood that the value of 20%, chosen as defining the power loss due to the electrical chain, may be modified to any other value depending on the characteristics of the device and of the method according to the invention without departing from the context of the latter.

Considering the particular case of a transfer power of 30 kW, the points concerned are therefore situated, in FIG. 4, below the isopower curve 30 kW, and below the isoconsumption curve of 300 g/kWh (namely 250 g/kWh+20%). They are represented by a cross-hatched zone in FIG. 4 corresponding to the present example supplied here as a nonlimiting example. It is evident that at these power levels (below 30 kW in our example), the high engine speeds will preferably be brought down by the interplay of the various stages of the transmission to engine speeds that are largely lower, thus limiting the cross-hatched zone of FIG. 4 to internal combustion engine speeds that are relatively low.

This zone corresponds to an operation of the ICE engine at low load and low speed, that is to say mainly in an urban cycle which represents the vast majority of cases of use of vehicles of the automobile type.

It is understood that the computer 14 at regular intervals compares the consumptions according to what has just been described and then determines the operating mode used. It then controls in consequence the engagement or disengagement of the clutch 10.

Moreover, depending on the configurations of the vehicle, the computer 14 controls the operation of the electrical machines 4, 9 to motor or generator mode.

More precisely, in a configuration of the vehicle in traction at low power, the computer 14 uses the intermittent series mode (clutch disengaged), with the ICE engine 1 used in on-off mode in its optimal operating zone in order to charge the SSEE 3, and the wheels 5 driven by the second electrical machine 4. In a configuration at normal power, the computer 14 uses the parallel mode (clutch engaged) with the ICE engine used continuously in order to directly drive the wheels 5 via the transmission members. The presence of the gearbox 11 helps to achieve the optimal operation of the ICE engine. In a configuration of traction at high power, for example during an acceleration, the computer 14 uses the parallel mode (clutch engaged), with the ICE engine 1 used continuously to directly drive the wheels 5, the two electrical machines 4, 9 can then also be used in motor mode in order to increase the power applied to the wheels 5. In a configuration of moderate deceleration, the computer 14 maintains the previously engaged mode (series, or parallel). A portion of the kinetic energy of the vehicle is recovered in the SSEE, either by the second electrical machine 4 (series mode), or by one or two electrical machines 4, 9 (parallel mode); the machines are then used as generators.

In a configuration of heavy deceleration, an additional deceleration can be achieved by engine braking by switching to parallel mode if necessary.

It is understood that the device and the method as they have been explained have several advantages.

A first advantage is a reduction in the fuel consumption that is greater than the series/parallel hybrid system of the prior art.

The device requires only a small-capacity battery which reduces the cost of said battery and its space requirement in the vehicle.

Similarly, the device allows the use of electrical machines of relatively low power because the electrical assistance is preferably requested only at low loads. Here again these elements are therefore of low cost and have a low space requirement.

The coupling-decoupling system 10 may if necessary be replaced by the gearbox clutch system that exists in the transmission member.

The management and control between the various modes are simple.

In the case of a complete design of the ICE engine, it would not be necessary to design internal combustion engines that are optimized over a very wide operating range because they would not be intended to operate at points of low load. Consequently, the efficiencies of these new heat engines over restricted ranges would be improved; the invention can however be achieved with an existing engine and gearbox without needing to develop a new internal combustion engine block for the hybrid vehicle concerned. This considerably reduces the development cost of the hybrid vehicle using the invention and allows the integration of the electromechanical chain from a conventional vehicle.

The scope of the present invention is not restricted to the details of the embodiments considered above as examples, but on the contrary extends to the modifications that are within the scope of those skilled in the art.

1. A motorization device for an hybrid land vehicle, said device comprising a first mechanical power transmission line (12) comprising an internal combustion engine (1) connected to a first electrical machine (9), a second mechanical power transmission line (13) comprising a second electrical machine (4) capable of rotating wheels (5) of the vehicle, the two electrical machines (9, 4) being able to be controlled as a motor or a generator, being connected to a system for storing electrical energy (3),
characterized in that the device also comprises:
an “on-off” coupling-decoupling system (10) for coupling-decoupling the two mechanical power transmission lines (12, 13),
means for controlling these various elements, connected to a computer (14),
means for comparison between:
on the one hand, the consumption of the internal combustion engine (1) in parallel mode, defined as a mode in which the shaft of the internal combustion engine (1) drives the wheels (5) via various members of mechanical gears, the two mechanical transmission lines (12, 13) being connected through the coupling device (10), that is to say the consumption of said internal combustion engine (1) at a given moment without electrical assistance and,
on the other hand, an equivalent consumption computed on the basis of the optimal consumption of the internal combustion engine (1) to which are added the losses due to the activation of the electrical chain (3, 4, 9) of the series mode, defined as being a mode in which the traction of the vehicle is provided only by the second electrical machine (4), the two mechanical transmission lines being separated by the coupling device (10), an intermittent use of the internal combustion engine (1) in an optimal operating zone corresponding to the zone of least fuel consumption making it possible to recharge the system for storing electrical energy (3) regularly in order to satisfy a continuous demand for power at the wheels (5).

2. The motorization device as claimed in claim 1, characterized in that it also comprises a gearbox (11) placed on one of the mechanical power transmission lines (12, 13).

3. The device as claimed in claim 1, characterized in that the two electrical machines (4, 9) are sized at a power of the order of 10 to 30 kW.

4. The device as claimed in claim 1, characterized in that the system for storing electrical energy (3) is of the rapid charge and discharge type.

5. A method for controlling a motorization device for an hybrid vehicle of the type corresponding to claim 1, characterized in that it consists in using at least two distinct architecture modes:
a parallel mode in which the shaft of the internal combustion engine (1) drives the wheels (5) via various members of mechanical gears, the two mechanical transmission lines (12, 13) being connected through the coupling device (10),
a series mode in which the traction of the vehicle is provided only by the second electrical machine (4), the two mechanical transmission lines being separated by the coupling device (10), an intermittent use of the internal combustion engine (1) in an optimal operating zone corresponding to the zone of least fuel consumption making it possible to recharge the system for storing electrical energy (3) regularly in order to satisfy a continuous demand for power at the wheels (5).

6. The method as claimed in claim 5, characterized in that the switch from one mode to the other is determined by a step for comparing between the consumption of the internal combustion engine (1) in parallel mode, that is to say the consumption of said internal combustion engine (1) at a given moment without electrical assistance, and an equivalent consumption computed on the basis of the optimal consumption of the internal combustion engine (1) to which are added the losses due to the activation of the electrical chain (3, 4, 9) of the series mode.

7. The method as claimed in claim 5, characterized in that, in a configuration of the vehicle in low-power traction, the computer (14) uses the series mode with intermittent use of the internal combustion engine (1).

8. The method as claimed in claim 5, characterized in that, in a configuration of traction of the vehicle at normal power, the computer (14) uses the parallel mode, and the internal combustion engine (1) is used only for driving the wheels (5).

9. The method as claimed in claim 5, characterized in that, in the configuration of traction of the vehicle at high power, for example in the event of considerable acceleration, the computer (14) uses the parallel mode, and the two electrical machines (4, 9) are used in drive mode in order to drive the wheels (5) in conjunction with the internal combustion engine (1).

10. The device as claimed in claim 2, characterized in that the two electrical machines (4, 9) are sized at a power of the order of 10 to 30 kW.

11. The method as claimed in claim 6, characterized in that, in a configuration of the vehicle in low-power traction, the computer (14) uses the series mode with intermittent use of the internal combustion engine (1).
